(19) United States
(12) Patent Application Publication
(10) Pub. No.: US 2008/0008346 A1
(43) Pub. Date: Jan. 10, 2008

(54) Dynamic reflection 4pi steradian omni directional tweeter

(75) Inventors: Dwidjaja Setiabudi, Kudus (ID); Adisusanto, Kudus (ID); Setiawan Yusran, Kudus (ID); Hadi Prayitno, Kudus (ID); Umar Singgih, Kudus (ID); Triyatno Aryadi, Kudus (ID)

Correspondence Address: ROTHWELL, FIGG, ERNST & MANBECK, P.C., 1425 K STREET, N.W., SUITE 800, WASHINGTON, DC, 20005, US

(73) Assignee: PT. Hartono Istana Teknologi, Kudus (ID)

(21) Appl. No.: 11/480,850

(22) Filed: Jul. 6, 2006

(51) Int. Cl. H04R 11/02

(52) U.S. Cl. 381/423; 381/424

(57) ABSTRACT

A 4π steradian omni directional tweeter has a closed hollow body acting as a dynamic reflector connected at the center topside of a diaphragm. A piezoelectric element or a voice coil drives the diaphragm. The closed hollow body can be sphere, spheroid, prolate spheroid, ellipse, ellipsoid, prolate ellipsoid, cylindrical, oblate shape, egg shape. In one embodiment, the closed hollow body is made of substance that has a light, rigid, seamless and uniform thickness similar to a bird or chicken egg. The dynamic reflector in the present invention moves simultaneously with its diaphragm to produce an omni directional radiation pattern. Compared with a static reflection system, the dynamic reflection system provides better phase response. Hence the reproduced sound is more realistic, has better precision, clarity and staging.

### FIELD OF THE INVENTION

The present invention relates to the field of electro acoustics for audio equipment, specifically for loudspeakers and particularly for a tweeter loudspeaker.

### BACKGROUND OF THE INVENTION

Presently there are many types of tweeters/high frequency loudspeakers, i.e. dynamic, planar, piezoelectric, and electrostatic tweeter, etc. Tweeters should reproduce a flat frequency response, good transient response and impulse response, good minimum phase response, crisp treble, good clarity, high sound pressure level and wide sound dispersion. The frequency response, impulse response, sound clarity and sound pressure level can be tuned with appropriate diaphragm shape, weight and material. Sound directivity depends on the sound frequency; at high frequencies, the sound is very directional toward the front of the driver and strong on axis. At mid frequencies, the sound is less directional and spreads laterally. The lower the frequency, the wider the spread, with the front intensity remaining the strongest.

Loudspeaker directivity results in loudspeaker placement significantly influencing the quality of reproduced sound. At high frequencies, the frequency response of the tweeter on axis and at 30° varies. This limitation has been the basis of many inventions of tweeter position adjustment. As examples, the following are representative of patents: Espiritu in U.S. Pat. No. 6,002,780, Fenton in U.S. Pat. No. 5,512,714 and Lin in U.S. Pat. No. 6,356,640, etc. These designs only mention the adjustment for tweeter position. The sound directivity of these arrangements remains narrow. If the position of the listener changes, the sound that he/she hears will also change and the tweeter position then requires adjustment. This is inconvenient and with some devices, to adjust the tweeter increases the cost of the loudspeaker.

Other prior art arrangements relate to omni directional tweeter loudspeakers discussed by Augustin in U.S. Pat. No. 6,064,744, Wiener in U.S. Pat. No. 5,673,329, Coziar in U.S. Pat. No. 5,306,880, Wolcott in U.S. Pat. No. 4,850,452 and Berlant in U.S. Pat. No. 4,348,549. These arrangements are down firing or up firing and employ a static diffuser or reflector to generate omni directional radiation of sound. Since the loudspeakers do not directly face the listener, the sound pressure level is relatively low. Further, these only use a static reflector to generate an omni directional pattern in a horizontal plane, not a 4π steradian omni directional.

Other prior art systems provide a plurality of tweeters in a system. This was set forth by Janszen in U.S. Pat. No. 3,931,867. This system, although useful, makes phase response control of the plural tweeters more difficult.

Further examples of omni directional loudspeaker systems have incorporated two identical electrodynamic loudspeakers arranged back to back on axis. The diaphragm employed in these arrangements uses a dome or conical shape as mentioned by Haas in U.S. Pat. No. 4,665,550 and Klein in U.S. Pat. No. 4,472,605. These structures do not produce a 4π steradian omni directional radiation, especially at high frequencies.

Conical diaphragm speakers have also been proposed which assemble an inverted and a radiating cap at the center axis, as mentioned by Allison in U.S. Pat. No. 4,029,910. This provides sound dispersion only equal to or slightly superior to that of the dome type loudspeakers and does not produce a 4π steradian omni directional radiation, especially at high frequencies.

All of the above limitations can be avoided by the application of a 4π steradian omni directional tweeter loudspeaker. The polar directivity of this system is more three-dimensionally distributed and approaches a spherical radiation pattern in 4π steradian space. With the instant invention, sound from the loudspeaker system can be heard with similar frequency response at any placement position of loudspeaker or listener in both a horizontal plane and a vertical plane. Thus, sound reproduction while standing or seated is similar. Similar reproduction of sound is also unaffected by the height of the loudspeaker placement.

The tweeter of the instant case can be used in audio components, televisions, home-theater systems, hi-fi components, vehicles, ceiling tweeters, etc. With a few modifications of the diaphragm shape, the tweeter can have a 2D (x,y) omni directional radiation. It is suitable for television applications, since the listener's ear is most certainly in a fixed 2D plane of the tweeters.

### SUMMARY OF THE INVENTION

One object of the present invention is to provide a 4π steradian omni directional tweeter. This tweeter has a hollow rounded structure acting as a dynamic reflector connected at the center topside of a conical diaphragm. The conical diaphragm can be made of polypropylene, paper, ceramic, cloth, silk, aluminum, titanium, or other material. A piezoelectric element or a voice coil drives the conical diaphragm. A frame supports the outer rim of the conical diaphragm. The hollow rounded structure can be a shape selected from a plurality of shapes, non-limiting examples which include spherical, elliptical, oblate or egg shaped. The hollow rounded structure is made of substance having a light, rigid, seamless and uniform thickness similar to the natural shell of a bird egg.

When using a natural egg, appropriate dimensions are carefully selected and the connection point made at the sharp pointed end of the egg. For the piezoelectric element driver, a matching transformer is required. In the case of a voice coil tweeter, a magnetic field generator is needed that consists of a top plate, magnet and U Yoke or T Yoke. The magnet material can be made of ferrite, alnico, Neodymium (NeFeB) or other magnetic material. The conical diaphragm mentioned above can have a dome or flat shape made of polypropylene, paper, cloth, silk, aluminum, titanium or other material. The invented tweeter is protected with a hemispherical or “U” shaped cover grill made of aluminum, plastic, or other material.

The dynamic reflector of the structure moves simultaneously with its conical diaphragm to produce the omni directional radiation pattern. This mechanism provides better minimum phase response compared to a static reflector system and thus the reproduced sound is closer to reality, resulting in better transient response and therefore, better sound staging. The reproduced sound has better clarity and precision.

A 4π steradian omni directional or spherical radiation pattern is obtained when the sound radiation intensity or the average sound pressure from a sound source is similar. The hollow rounded structure produces the sound field and consists of sound radiation from the hollow rounded structure, sound from the conical diaphragm reflected by hollow rounded structure and sound transmitted through the hollow rounded structure.

The omni directional pattern of the hollow rounded structure diaphragm depends on its shape, such as an egg, sphere, ellipse or oblate shape. Comparing between the egg shape, spherical shape and elliptical shape, the best structure to obtain 2D omni directional pattern in the horizontal plane (perpendicular to its axis) is the egg shape. This is due to the reflected sound being evenly spread in the plane perpendicular to its axis. To obtain a good 4π steradian omni directional, the sound radiation on the vertical plane (parallel to the axis) should be similar to the sound radiation on the horizontal plane. It has been found that the egg shaped diaphragm is the best structure, since this structure reduces the axially transmitted sound from the conical diaphragm.

In front mounted tweeter arrangements, the benefit of higher SPL with better dispersion is best obtained with the oblate shape, since sound radiation to the front is required. The total response of the structure depends on the size of the hollow rounded structure and conical diaphragm mounting. In this kind of mounting, the radiation of the tweeter in accordance with the present invention will be half of the original.

The hollow rounded structure can be made by injection molding, metalizing or other suitable methods. When using injection molding, the material may be polypropylene, plastic with ceramic, plastic with fiber, or another engineering plastic material. In metal arrangements, the material may be aluminum, titanium or other metal material. The important parameters of the structure include lightweight structure, rigidity, seamlessness and uniform thickness.

Another objective of the present invention is to provide a 2D omni directional tweeter loudspeaker. It may be made with a few modifications of a 4π steradian omni directional tweeter. It uses two conical diaphragms in facing relation, instead of one conical diaphragm and a cylindrical diaphragm that connects between the two conical diaphragms replacing the hollow rounded shaped structure. The cylindrical diaphragm can be made of paper, aluminum, polypropylene or other plastic material. Each conical diaphragm can be driven by a piezoelectric element or a voice coil. In a piezoelectric application, a matching transformer is needed; each piezoelectric element connected to the matching transformer then cooperate together in a push/pull mounting to duplicate the diaphragm movement direction.

The 4π steradian and 2D omni directional tweeter may be used in a television set, audio component, high fidelity system, home theater system, automotive vehicle, ceiling, or a multi-media loudspeaker without being limiting. For high fidelity and home theater loudspeakers, the placement of the tweeter is at the top of the enclosure. In front mounting systems such as audio components and televisions or other equipment, the tweeter will have a semi cylindrical shell to isolate it from woofer radiation. An absorber is inserted between the shell and the tweeter. In this mounting, the radiation of the tweeter will be half of the original.

A further objective of one embodiment of the present invention is to provide a dynamically reflecting 4π steradian omni directional loudspeaker diaphragm, comprising a loudspeaker diaphragm and a dynamic reflector connected to the loudspeaker diaphragm for simultaneous movement with the diaphragm, the reflector comprising a closed hollow body having a shape selected from the group consisting of a sphere, spheroid, ellipse, ellipsoid and egg shape.

A further objective of one embodiment of the present invention is to provide a dynamically reflecting 4π steradian omni directional loudspeaker, comprising in combination the diaphragm, a frame for supporting the diaphragm and the reflector, and electrical means connected to the diaphragm for transmitting electrical signals from an electrical signal source to the diaphragm for the production of audible frequency in an omni directional radiation pattern.

Yet another objective of one embodiment of the present invention is to provide a method of regulating the phase response of a loudspeaker to provide an omni directional radiation pattern, comprising providing a loudspeaker diaphragm, providing a dynamic reflector connected to the loudspeaker diaphragm for simultaneous movement with the diaphragm, the reflector comprising a closed hollow body having a shape selected from the group consisting of a sphere, spheroid, ellipse, ellipsoid and egg shape, providing electrical means connected to the diaphragm for transmitting electrical signals from an electrical signal source to the diaphragm for the production of audible frequency in an omni directional radiation pattern; and passing an electrical signal through the electrical means to generate an omni directional radiation pattern with regulated phase response.

Having thus generally described invention, reference will now be made to the accompanying drawings.

### BRIEF DESCRIPTION OF THE DRAWINGS

FIG. 1 is a cross section of the 4π steradian omni directional tweeter loudspeaker according to one embodiment of the present invention, using piezoelectric element and conical diaphragm;

FIG. 2 is a cross section of an alternative 4π steradian omni directional tweeter loudspeaker according to one embodiment of the present invention, using a voice coil of the electrodynamic tweeter driver and conical diaphragm;

FIG. 3 is a cross section of an alternative 4π steradian omni directional tweeter loudspeaker according to one embodiment of the present invention, using a voice coil of the electrodynamic tweeter driver and dome diaphragm;

FIG. 4 is a cross-section the 4π steradian omni directional tweeter loudspeaker according to a further embodiment of the present invention, using a piezoelectric element;

FIG. 5 is a cross-section of a further embodiment of the present invention of the 4π steradian omni directional tweeter loudspeaker, using a voice coil of the electrodynamic tweeter driver and conical diaphragm that connects to a spherical shape diaphragm;

FIG. 6 is a cross-section of a further embodiment of the present invention of the 4π steradian omni directional tweeter loudspeaker, using a voice coil of the electrodynamic tweeter driver and dome diaphragm that connects to a spherical shape diaphragm;

FIG. 7 is a cross-section of a further embodiment of the present invention of the 4π steradian omni directional tweeter loudspeaker, using a piezoelectric element;

FIG. 8 is a cross-section of a further embodiment of the present invention of the 4π steradian omni directional tweeter loudspeaker, using a voice coil of the electrodynamic tweeter driver and conical diaphragm that connects to an elliptical shape diaphragm;

FIG. 9 is a cross-section of a further embodiment of the present invention of the 4π steradian omni directional tweeter loudspeaker, using a voice coil of the electrodynamic tweeter driver and dome diaphragm that connects to an elliptical shape diaphragm;

FIG. 10 is a cross section of the 2D omni directional tweeter loudspeaker according to the present invention;

FIG. 11 is a cross section of a front mounting the 4π steradian omni directional tweeter according to the present invention, using an egg shaped diaphragm;

FIG. 12 is a cross section of a front mounting the 4π steradian omni directional tweeter according to the present invention, using a spherical shaped diaphragm;

FIG. 13 is a cross section of a front mounting 2D omni directional tweeter loudspeaker according to the present invention;

FIG. 14 is a perspective view of the 4π steradian omni directional tweeter loudspeaker according to the present invention, using an egg shaped diaphragm connected at the top, side and center axis with the conical diaphragm;

FIG. 15 is a schematic illustration of a microphone track position of the 4π steradian polar measurement;

FIG. 16 is a graphical representation of the polar directivity measurement (vertical plane and parallel to the axis) of a conventional tweeter without a dynamic reflector;

FIG. 17 is a graphical representation of the polar directivity measurement (vertical plane and parallel to the axis) of the tweeter according to the present invention with a dynamic reflector;

FIG. 18 is a graphical representation of the polar directivity measurement (horizontal plane and perpendicular to the axis) of a conventional tweeter without a dynamic reflector; and

FIG. 19 is a graphical representation of the polar directivity measurement (horizontal plane and perpendicular to the axis) of the tweeter according to the present invention with a dynamic reflector.

### DETAILED DESCRIPTION OF THE PREFERRED EMBODIMENTS

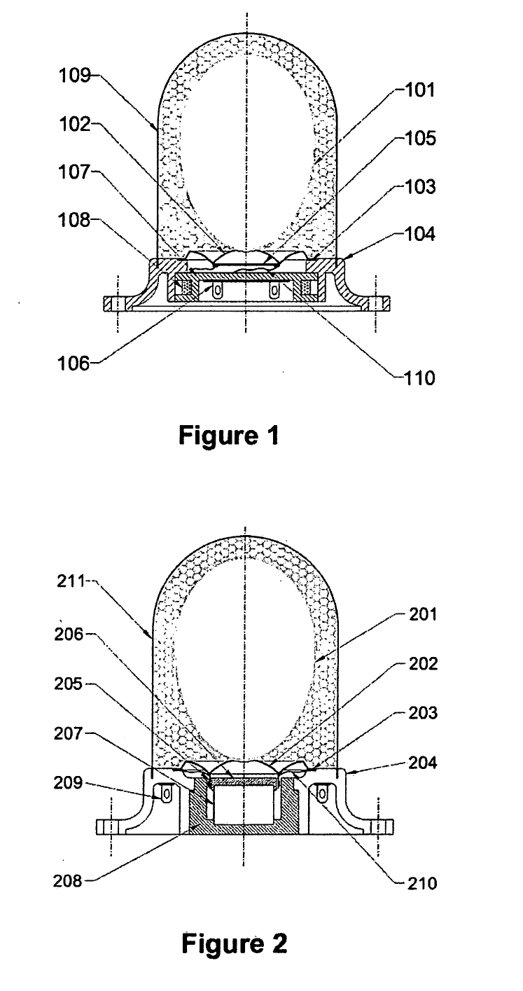

Referring to FIG. 1, numeral 101 denotes a hollow rounded structure having an egg shaped diaphragm connected at the center topside of the conical diaphragm 102. The connection point of the egg shaped diaphragm 101 is its pointed end. An outer rim of the conical diaphragm 103 is connected to a supporting frame 104. The conical diaphragm is driven by a piezoelectric element 105 attached at the bottom side of the diaphragm. The audio signal connected to the piezoelectric element 105 at a terminal 106 of the matching transformer that consists of a coil bobbin 107 and a matching coil 108. A cover grill that has a hemispherical shape or a “U” shape 109 covers the tweeter for protection.

An alternative of the tweeter employing a voice coil instead of piezoelectric elements 105, is shown in FIG. 2. In this case, a magnetic field generator is required. Referring to FIG. 2, numeral 201 denotes a hollow rounded shaped structure having an egg shaped diaphragm connected at the center topside of the conical diaphragm 202. The conical diaphragm 202 is connected at the outer rim to a supporting frame 204. The bottom side of the diaphragm is connected to a voice coil 205. Voice coil 205 drives the magnetic field that is generated by a top plate 206, a cylindrical magnet 207 and a “U” shaped plate 208. The magnet may be made from ferrite, alnico, Neodymium (NeFeB) or any other suitable magnetic material. The voice coil 205 is connected to the tweeter terminal 209 through a pair of brass wires 210. A cover grill has a “U” shape serving to protect the tweeter.

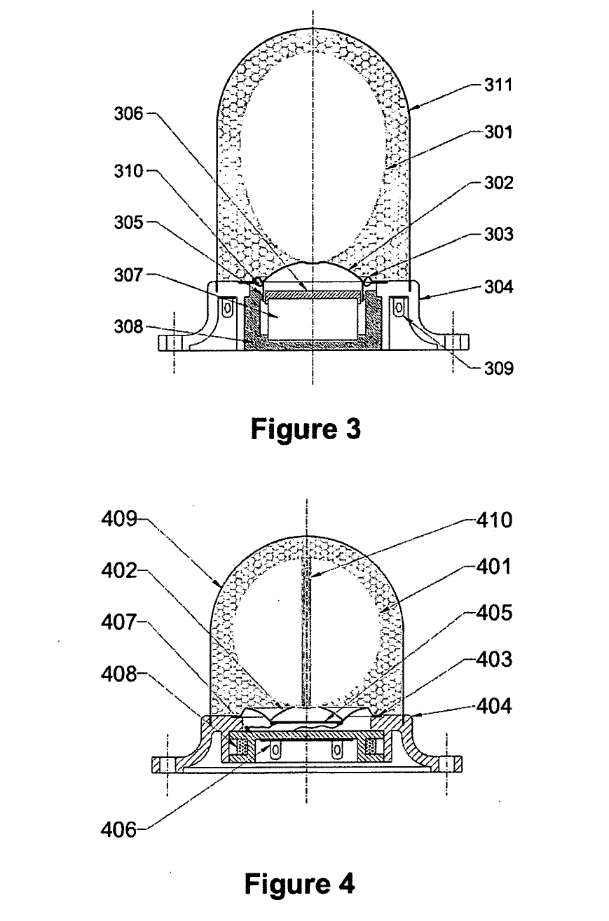

FIG. 3 illustrates a further alternative of the tweeter which employs a dome shaped diaphragm instead of conical shaped diaphragm. The hollow rounded shaped structure has an egg shaped diaphragm 301 connected at its center axis and at the top of the dome shaped diaphragm 302. The latter has an edge 303 at the outer rim for maintaining compliance of the diaphragm. The frame structure 304 supports the dome diaphragm at the outer rim. The bottom side of dome diaphragm is connected to a voice coil 305, which drives the magnetic field generated by a top plate 306, a cylindrical magnet 307 and a “U” shaped plate 308. A terminal 309 is connected to the outer of frame structure 304.

In a further embodiment, FIGS. 4 through 6 illustrate another alternative of the tweeter employing a hollow rounded shaped structure which has a spherical shaped diaphragm instead of an egg shaped diaphragm. Referring to FIG. 4, a spherical shaped diaphragm 401 is connected at the center topside of the conical diaphragm 402. When injection molding is used to produce the spherical diaphragm, the seam is denoted by numeral 410. The remaining features are similar to FIG. 1 with the numeral changing to 4xx instead of 1xx.

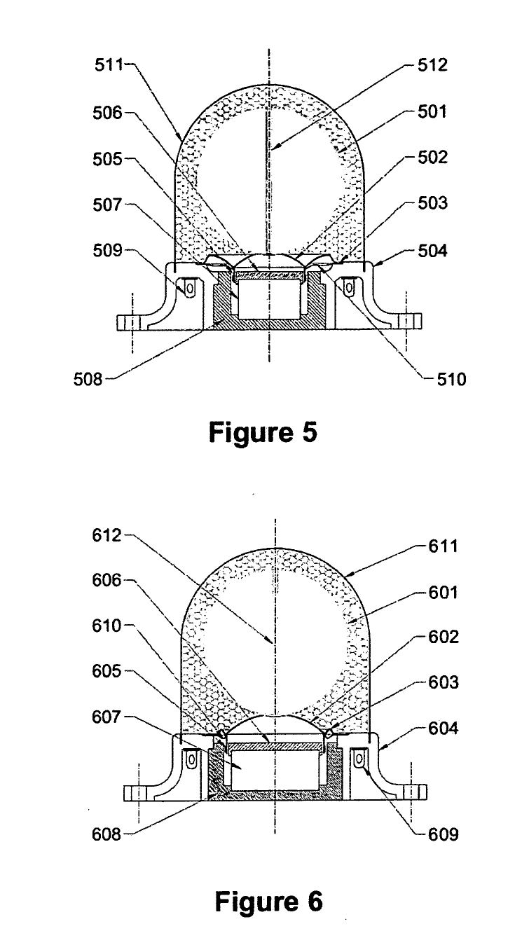

Referring to FIG. 5 shown is a spherical shaped diaphragm 501 connected at the center top of the conical diaphragm 502. At the bottom of conical diaphragm 502 is connected a voice coil tweeter 505. Similar features from FIG. 2 apply with the numbering changed to 5 series.

Turning to FIG. 6, spherical shaped diaphragm 601 is connected as previously discussed with other embodiments to the dome diaphragm 602. Dome diaphragm 602 connects a voice coil tweeter 605; the remaining construction is similar to FIG. 3 with the numeral changing to 6xx instead of 3xx.

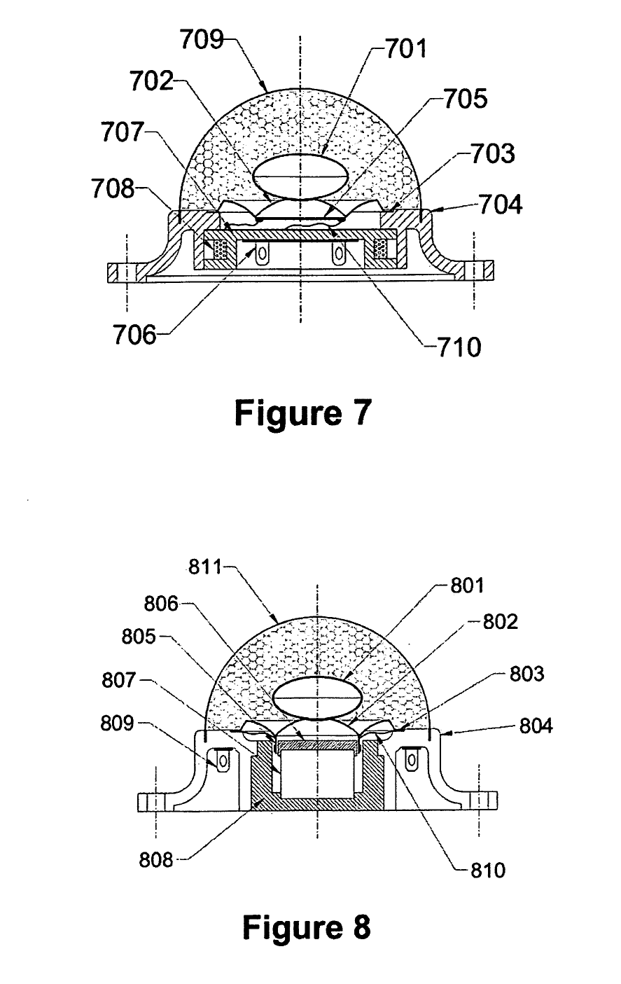

Another alternative of tweeter incorporates an oblate diaphragm instead of an egg shaped diaphragm, as shown in FIGS. 7, 8 and 9. Referring to FIG. 7, an oblate shaped diaphragm 701 connects at the center topside of the conical diaphragm 702, with similar features to those previously described.

Referring now to FIG. 8, the oblate diaphragm 801 is connected to the conical diaphragm 802. The bottom diaphragm 802 connects a voice coil tweeter 805. Similar numbering applies as noted previously.

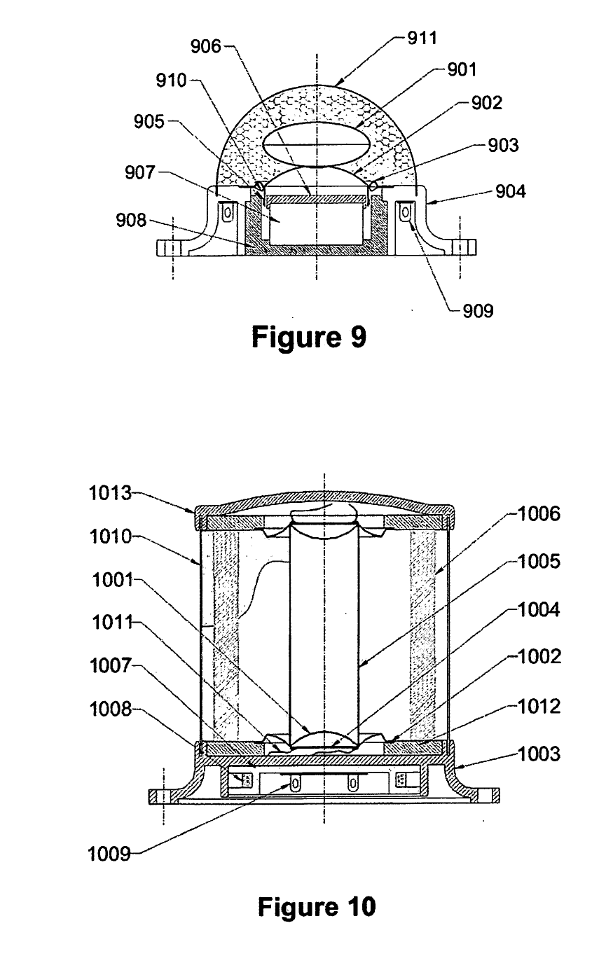

In reference to FIG. 9, diaphragm 901 is connected to the dome diaphragm 902. As previously discussed with previous embodiments, dome diaphragm 902 connects a voice coil tweeter 905. The rest of construction is similar to FIG. 3 and as such, the first character of the numeral changes to 9xx instead of 3xx.

Another embodiment of the invention is to provide a 2D omni directional tweeter, as shown in FIG. 10. Numeral 1001 denotes two conical diaphragms in facing relation. The conical diaphragm has an edge 1002 at the outer rim and is supported by a frame 1003. The bottom side of the conical diaphragm includes a piezoelectric element 1004. A cylindrical diaphragm 1005 which may be made from paper, polypropylene, ceramic, aluminum or other material is connected between the two conical diaphragms. Both frames of the conical diaphragm 1003 are supported by three hollow structures 1006. Both piezoelectric elements can be connected out of phase in series or parallel to the matching transformer comprising bobbin 1007 and matching coil 1008. A Terminal 1009 is used to connect the input audio signal to the matching transformer through a pair of brass wires 1011. A cover grill 1010 has a cylindrical shape and covers the tweeter for protection.

The above of 4π steradian omni directional tweeter may be used in audio components, television sets, hi-fi systems, home-theater systems, vehicles and ceiling loudspeakers, as examples. For audio components, televisions, hi-fi systems and home-theater systems, the placement of the tweeter is suitable at the topside. In the situation where the tweeter is ceiling mounted, by installing several at an appropriate distance and combining them with conventional ceiling loudspeakers for low and mid frequency, the sound frequency response is similar at any position in the room. In automotive applications, loudspeaker placement is typically at the door, which is not an ideal position for the listener. By installing the tweeter according to the present invention separately from the woofer at any position in the vehicle, i.e. at the door, the dashboard, etc, the sound frequency response is similar at any position in the vehicle.

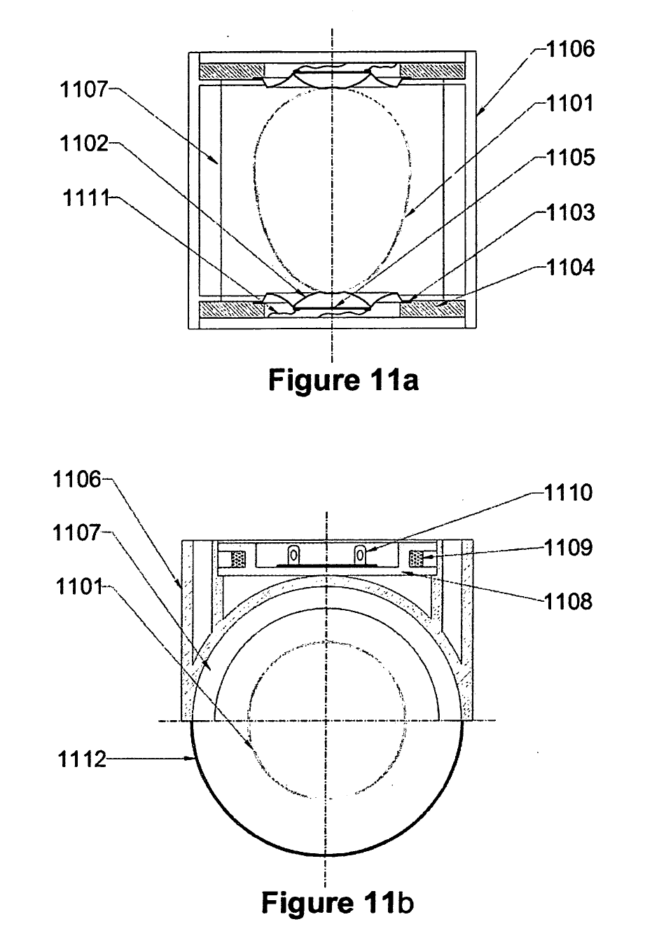

Conventionally tweeter placement is positioned at the front face of the unit. This is especially true for television sets and audio components. Other mounting possibilities using the tweeter is front mounting position, as shown in FIGS. 11, 12 and 13. In this mounting, the polar radiation of the tweeter will be half of the original.

Referring to FIG. 11a, shown is a cross-sectional view; FIG. 11b is a top view. The egg shaped diaphragm 1101 is connected between two conical diaphragms 1102. The other side of each conical diaphragm 1102 is connected to a piezoelectric element 1105. Each conical diaphragm 1102 is supported by a frame 1104 at the outer rim 1103. Each supporting frame 1104 is connected perpendicularly to a semi-cylindrical shell 1106 for isolation from woofer sound radiation. The semi-cylindrical shell 1106 may be made from plastic, aluminum or other suitable material. An absorber 1107, inserted in between the shell and the tweeter, reduces unwanted sound reflection. Both piezoelectric elements 1105 may be connected out of phase in series or parallel to the matching impedance that consists of a bobbin 1108 and a matching coil 1109. The audio signal input is connected to the matching transformer through a terminal 1110 and a pair of brass wires 1111. A cover grill 1112 has a hemi cylindrical shape and covers the tweeter for protection.

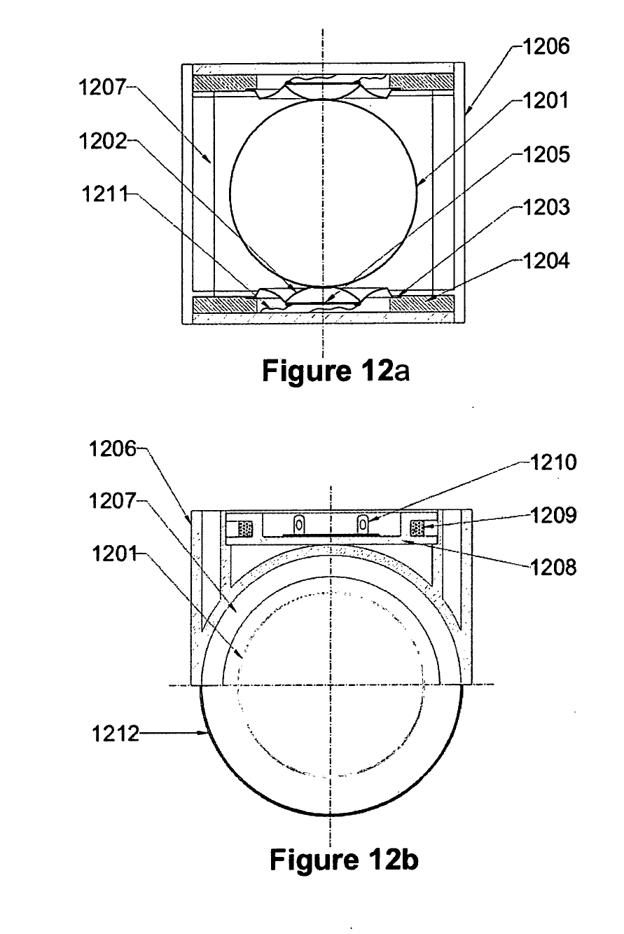

Referring to FIG. 12a, shown is a cross-sectional view; FIG. 12b is a top view. A spherically shaped diaphragm 1201 is connected between two conical diaphragms 1202 instead of the egg shaped diaphragm, to produce a front mounting 4π steradian omni directional tweeter loudspeaker. The rest of the construction is similar to that disclosed for FIGS. 11a and 11b, with a commensurate numeral change to 12xx. Preferably the spherical shaped diaphragm is made from a table tennis ball material or from polypropylene, paper, ceramic, fiber or other material using injection-molding or aluminum or titanium using a metalizing process. This kind of mounting produces radiation of the tweeter of the original.

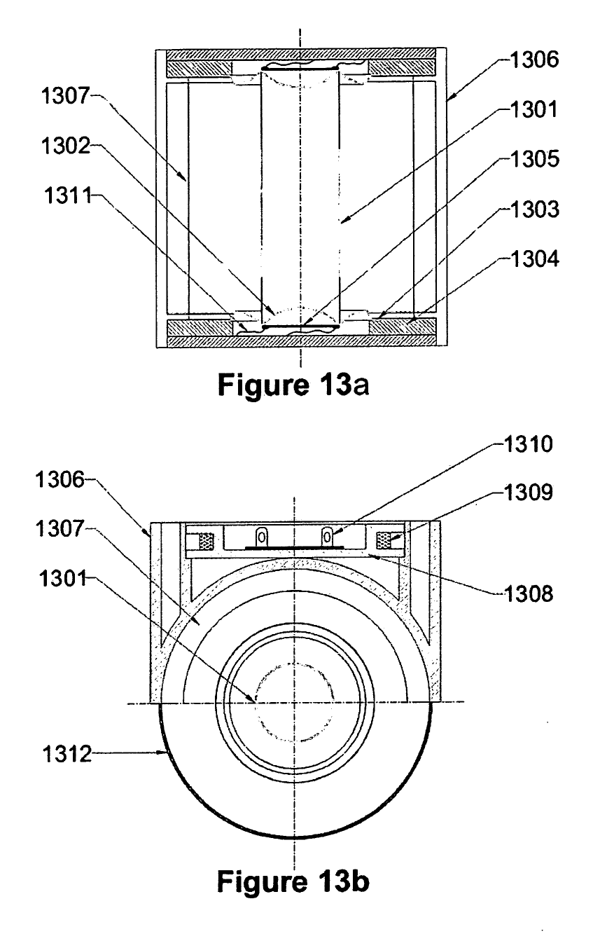

Referring to FIG. 13a, shown is a cross-sectional view; FIG. 13b is a top view. A cylindrical shaped diaphragm 1301 is connected between two conical diaphragms 1302 instead of the egg shaped diaphragm to produce a front mounting 2D omni directional tweeter loudspeaker. A semi cylindrical shell 1306 composed of plastic or aluminum connects perpendicularly to both supporting frames 1304 for isolation of the woofer sound radiation. An absorber 1307 inserted between the shell and the tweeter reduces unwanted sound reflection. The remaining construction is similar to FIGS. 10a and 10b.

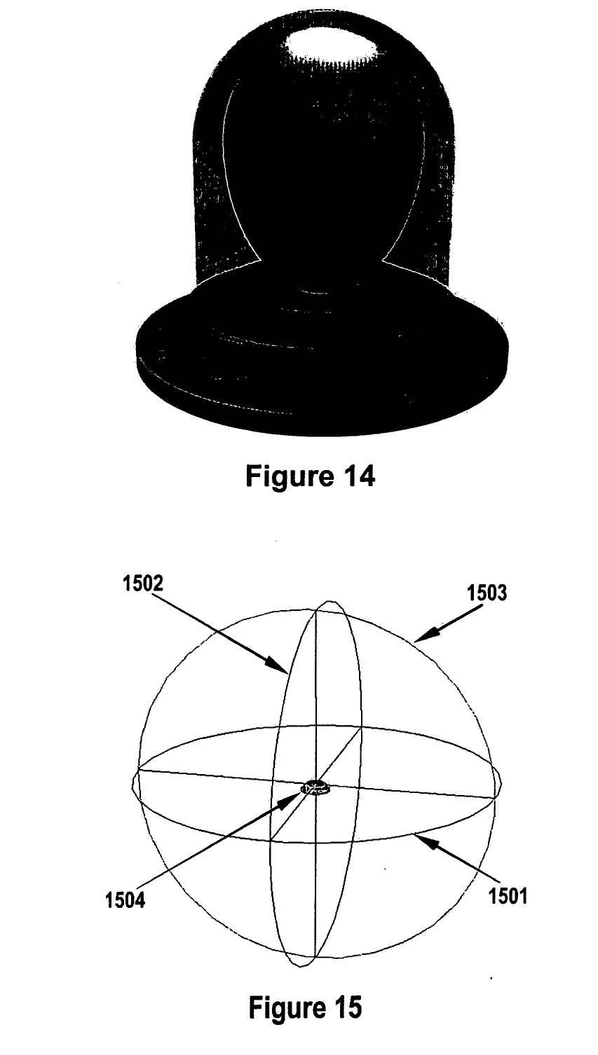

Referring to FIG. 14, shown is an example of the 4π steradian omni directional tweeter loudspeaker according to the present invention, using an egg shaped diaphragm connected at the top view and center axis with the conical diaphragm. The piezoelectric element and the matching transformer are inside the frame (not shown). The cross-section of this embodiment is shown in FIG. 1.

FIG. 15 is a schematic illustration of the microphone track position of the 4π steradian polar measurement. Numeral 1504 denotes the position of the tweeter. There are two planes of measurement, namely the horizontal plane (perpendicular to its axis) denoted by numeral 1501 and the vertical plane (parallel to the axis) denoted by numerals 1502 and 1503.

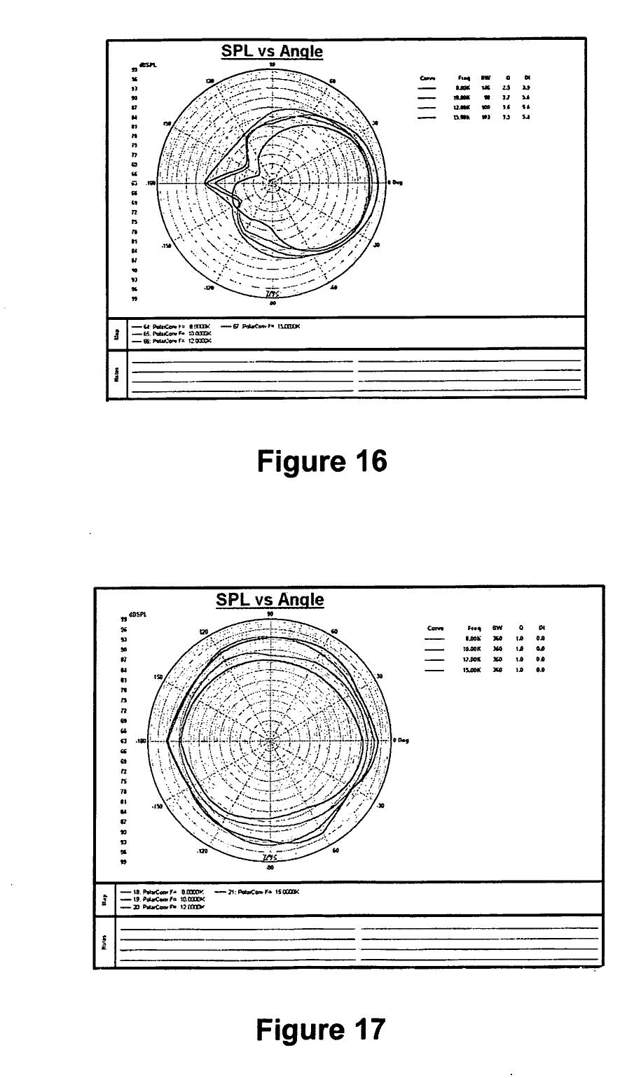

FIG. 16 is a graphical illustration of the polar directivity measurement vertical plane (parallel to the axis) of a conventional tweeter without the dynamic reflector. At a frequency of 8 kHz, the directivity factor Q is 2.5, at 10 kHz is 3.7, at 12 kHz is 3.6, and at 15 kHz is 3.5. Accordingly, the directivity factor Q increases with frequency.

FIG. 17 is a graphical illustration of the polar directivity measurement vertical plane (parallel to the axis) of the tweeter of the present invention using a dynamic reflector. The polar pattern at frequencies of 8K, 10K, 12K, and 15K are almost circular in shape, with the directivity factor, Q, equal to 1, an almost ideal omni directional polar pattern.

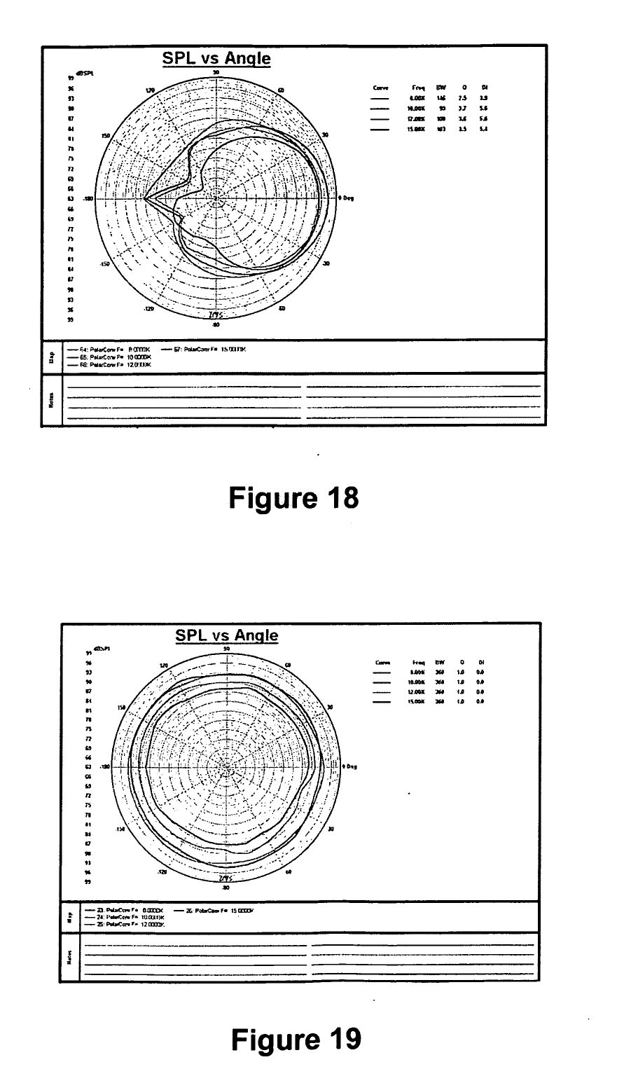

FIG. 18 is a graphical illustration of the polar directivity measurement horizontal plane (perpendicular to the axis) of a conventional tweeter without making use of a dynamic reflector. It is shown that at frequency 8 kHz, the directivity factor, Q, is equal to 2.5, at 10 kHz is 3.7, at 12 kHz is 3.6, and at 15 kHz is 3.5. Accordingly, the directivity factor Q increases with the frequency.

FIG. 19 is a graphical illustration of the polar directivity measurement horizontal plane (parallel to the axis) of the tweeter of the present invention using a dynamic reflector. It shown that on both the horizontal and vertical planes the polar pattern at frequencies of 8K, 10K, 12K, and 15K are almost circular in shape, with the directivity factor Q equal to 1.

Although embodiments of the invention have been described above, it is limited thereto and it will be apparent to those skilled in the art that numerous modifications form part of the present invention insofar as they do not depart from the spirit, nature and scope of the claimed and described invention.

We claim:

1. A dynamically reflecting 4π steradian omni directional loudspeaker diaphragm, comprising:
a loudspeaker diaphragm; and
a dynamic reflector connected to said loudspeaker diaphragm for simultaneous movement with said diaphragm, said reflector comprising a closed hollow body.

2. The loudspeaker diaphragm as set forth in claim 1, wherein said hollow body has a shape selected from the group consisting of a sphere, spheroid, ellipse, ellipsoid and egg shape.

3. The loudspeaker diaphragm as set forth in claim 1, wherein said dynamic reflector comprises a prolated spheroid.

4. The loudspeaker diaphragm as set forth in claim 1, wherein said dynamic reflector comprises a prolated ellipsoid.

5. The loudspeaker diaphragm as set forth in claim 1, wherein said dynamic reflector is connected in coaxial relation with said loudspeaker diaphragm.

6. The loudspeaker diaphragm as set forth in claim 1, wherein said hollow body has a substantially uniform thickness dimension over the entire surface thereof.

7. The loudspeaker diaphragm as set forth in claim 1, wherein said hollow body comprises a material selected from the group consisting of polyethylene, polystyrene, polyvinyl chloride, polyethylene terephthalate, polyvinyl fluoride, polycarbonate, ceramics, composite material, aluminum, titanium stainless steel, gold, silver, copper, tin, porcelain, paper, textiles and combinations thereof.

8. The loudspeaker diaphragm as set forth in claim 1, wherein said loudspeaker diaphragm comprises a material selected from the group consisting of polyethylene, polystyrene, polyvinyl chloride, polyethylene terephthalate, polyvinyl fluoride, polycarbonate, ceramics, composite material, aluminum, titanium stainless steel, gold, silver, copper, tin, porcelain, paper, textiles and combinations thereof.

9. The loudspeaker diaphragm as set forth in claim 1, wherein said loudspeaker diaphragm has a profile selected from the group consisting of flat, conic and domed.

10. The loudspeaker diaphragm as set forth in claim 1, wherein said loudspeaker diaphragm comprises a tweeter diaphragm.

11. A dynamically reflecting 4π steradian omni directional loudspeaker, comprising in combination:
said diaphragm of claim 1;
a frame for supporting said diaphragm and said reflector; and
electrical means connected to said diaphragm for transmitting electrical signals from an electrical signal source to said diaphragm for the production of audible frequency in an omni directional radiation pattern.

12. The loudspeaker as set forth in claim 11, wherein said loudspeaker is mounted in a loudspeaker housing.

13. The loudspeaker as set forth in claim 12, wherein said housing includes a plurality of loudspeaker drivers.

14. The loudspeaker as set forth in claim 11, further including a sound absorption medium for absorbing low frequencies.

15. The loudspeaker as set forth in claim 11, further including a protective cover for placement about said diaphragm and said reflector.

16. The loudspeaker as set forth in claim 1, further including a protective cover for placement about said diaphragm and said reflector.

17. A method of regulating the phase response of a loudspeaker to provide an omni directional radiation pattern, comprising;
providing a loudspeaker diaphragm;
providing a dynamic reflector connected to said loudspeaker diaphragm for simultaneous movement with said diaphragm, said reflector comprising a closed hollow body having a shape selected from the group consisting of a sphere, spheroid, ellipse, ellipsoid and egg shape;
providing electrical means connected to said diaphragm for transmitting electrical signals from an electrical signal source to said diaphragm for the production of audible frequency in an omni directional radiation pattern; and
passing an electrical signal through said electrical means to generate an omni directional radiation pattern with regulated phase response.
